(19) United States
(12) Patent Application Publication
(10) Pub. No.: US 2014/0145904 A1
(43) Pub. Date: May 29, 2014

(54) ANTENNA DEVICE

(71) Applicant: Kabushiki Kaisha Tokai Rika Denki Seisakusho, Aichi (JP)

(72) Inventors: Fumitaka YOSHIKAWA, Aichi (JP); Motoki NAKAGAWA, Aichi (JP)

(73) Assignee: KABUSHIKI KAISHA TOKAI RIKA DENKI SEISAKUSHO, Aichi (JP)

(21) Appl. No.: 14/075,326

(22) Filed: Nov. 8, 2013

(30) Foreign Application Priority Data
Nov. 27, 2012 (JP) 2012-258923

(51) Int. Cl. H01Q 7/00

(52) U.S. Cl. CPC H01Q 7/00
USPC 343/867

(57) ABSTRACT

An antenna device is provided with first and second bobbins. The first bobbin includes an end wall and a hollow interior. A first antenna coil is wound around the first bobbin. A second antenna coil is wound around the second bobbin. The first bobbin includes two terminals arranged on the end wall and electrically connected to two ends of the first antenna coil, respectively. The end wall includes two through holes that extend to the hollow interior of the first bobbin. The second bobbin includes two terminals electrically connected to two ends of the second antenna coil, respectively. The second bobbin is accommodated in the hollow interior of the first bobbin. The two terminals of the second bobbin are inserted through the two through holes, respectively.

### CROSS-REFERENCE TO RELATED APPLICATIONS

This application is based upon and claims the benefit of priority from prior Japanese Patent Application No. 2012-258923, filed on Nov. 27, 2012, the entire contents of which are incorporated herein by reference.

### BACKGROUND OF THE INVENTION

The present invention relates to an antenna device that includes two antenna coils.

International Patent Application Publication No. WO2007/116623 describes an antenna device that includes two antenna coils. In addition to the two antenna coils, the antenna device of International Patent Application Publication No. WO2007/116623 includes two cores that intersect each other so as to form a cross. The two antenna coils are each wound around one of the two cores. The two cores are arranged in a box-shaped case. Terminals connected to the antenna coils are arranged on the outer surface of each of the two opposing side walls of the case. In detail, two terminals are arranged on the outer surface of one of the opposing side walls of the case. Each terminal is connected to one end of one of the two antenna coils. Further, two terminals are arranged on the outer surface of the other of the opposing side walls of the case. Each terminal is connected to the other end of one of the two antenna coils.

When electrically connecting the antenna device of International Patent Application Publication No. WO2007/116623 to a communication device such as a transmitter or a receiver, the terminals on the two opposing side walls of the antenna device case are connected to the communication device. In detail, to connect the antenna device to the communication device, a step of electrically connecting the terminals arranged on the outer surface of one side wall of the case to the communication device, and a step of electrically connecting the terminals arranged on the outer surface of the other side wall of the case to the communication device are performed. In this manner, many steps are carried out to electrically connect the antenna device and the communication device.

### SUMMARY OF THE INVENTION

One aspect of the present invention is an antenna device provided with a first bobbin and a second bobbin. The first bobbin includes an end wall and a hollow interior. A first antenna coil is wound around the first bobbin. A second antenna coil is wound around the second bobbin. The first bobbin includes two terminals arranged on the end wall and electrically connected to two ends of the first antenna coil, respectively. The end wall includes two through holes that extend to the hollow interior of the first bobbin. The second bobbin includes two terminals electrically connected to two ends of the second antenna coil, respectively. The second bobbin is accommodated in the hollow interior of the first bobbin. The two terminals of the second bobbin are inserted through the two through holes, respectively.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of an antenna device according to one embodiment of the present invention;

FIG. 2 is an exploded perspective view of the antenna device shown in FIG. 1;

FIG. 3 is a front view of a first bobbin in the antenna device shown in FIG. 1;

FIG. 4 is a plan view of the first bobbin shown in FIG. 3;

FIG. 5 is a side view of the first bobbin shown in FIG. 3;

FIG. 6 is a front view of a second bobbin in the antenna device shown in FIG. 1;

FIG. 7 is a plan view of the second bobbin shown in FIG. 6;

FIG. 8 is a side view of the second bobbin shown in FIG. 6;

FIG. 9 is a cross-sectional view of an antenna device shown in FIG. 1;

FIG. 10 is a cross-sectional view of the antenna device taken along line X-X in FIG. 9; and

FIG. 11 is a cross-sectional view of an antenna device according to a further embodiment of the present invention.

### DETAILED DESCRIPTION OF THE INVENTION

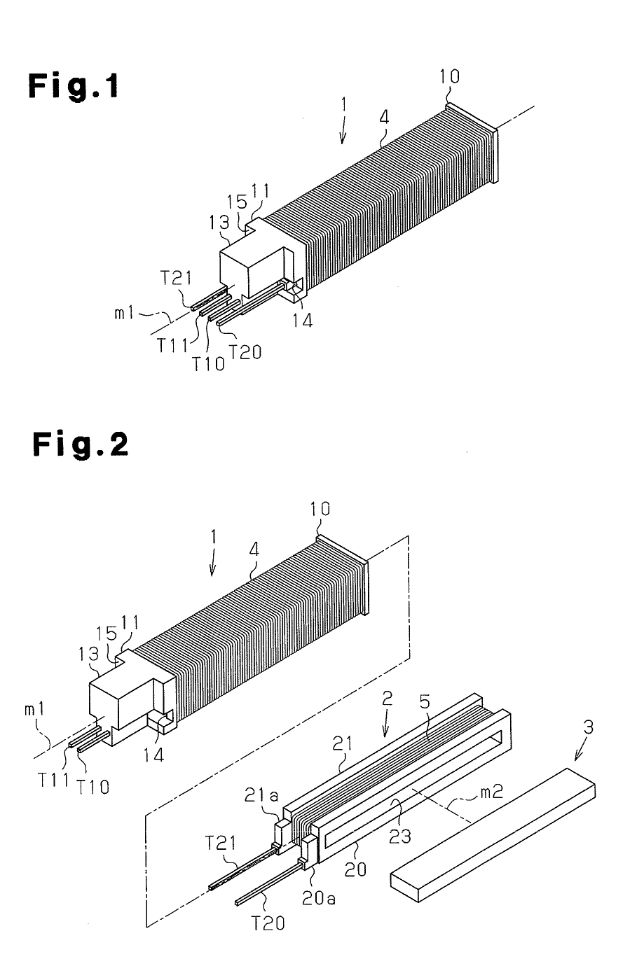

An antenna device according to one embodiment of the present invention will now be described with reference to FIGS. 1 to 10. The antenna device of the present invention is arranged in, for example, a handle of a vehicle door and used to transmit radio waves on a low frequency (LF) band to a region near the vehicle door.

Referring to FIGS. 1 and 2, the antenna device of the present embodiment includes a first bobbin 1 having a hollow interior, a second bobbin 2 accommodated in the hollow interior of the first bobbin 1, and a core 3 arranged in the second bobbin 2. In one example, the first bobbin 1 is box-shaped, the second bobbin 2 is parallelepiped, and the core 3 is planar. The bobbins 1 and 2 are each formed from a resin, and the core 3 is formed from a magnetic material such as ferrite. A first antenna coil 4 is wound around the first bobbin 1 about a center line (first axis m1) of the first bobbin 1. A second antenna coil 5 is wound about the second bobbin 2 about a second axis m2, which is orthogonal to the first axis m1. Thus, the antenna axes of the antenna coils 4 and 5 are orthogonal to each other. Due to the antenna coil 4 and 5, the antenna device of the present embodiment has directivity in the directions of two orthogonal axes.

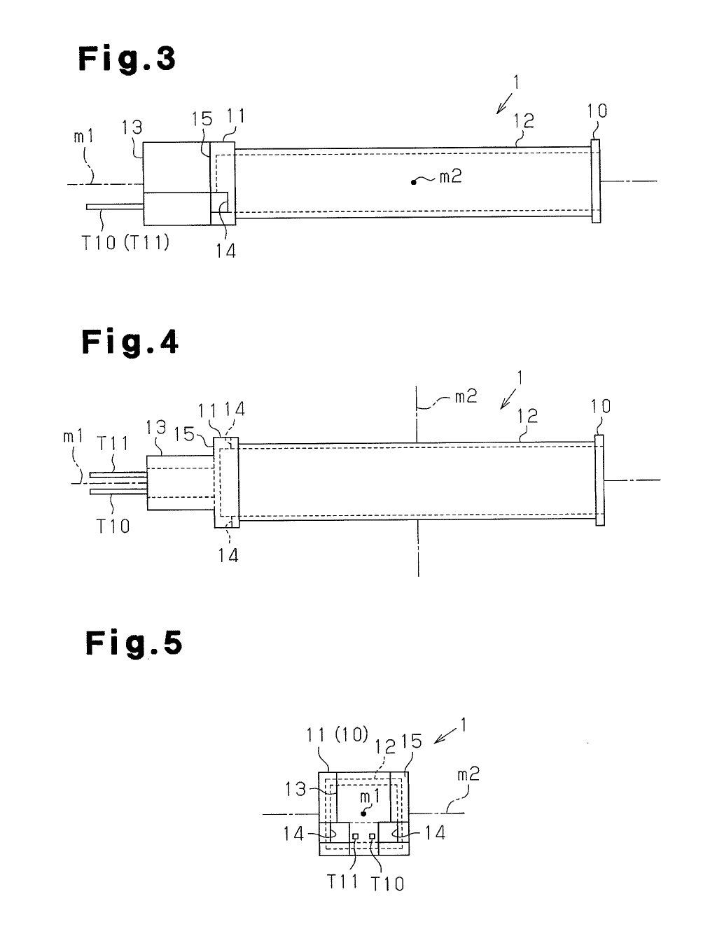

The structure of the first bobbin 1 will now be described in detail with reference to FIGS. 3 and 4.

The first bobbin 1 extends along the first axis m1 and includes flanges 10 and 11 located on its two ends. The first bobbin 1 includes a peripheral surface that defines a coil seat 12 around which the first antenna coil 4 is wound. The coil seat 12 extends between the flanges 10 and 11. The end of the first bobbin 1 proximal to the flange 10 is open, and the end of the first bobbin 1 proximal to the flange 11 is closed. Accordingly, the first bobbin 1 includes an end wall 15 proximal to the flange 11. A connector 13 extends from the outer surface of the end wall 15 along the first axis m1. The connector 13 has a T-shaped cross-section in a direction orthogonal to the first axis m1. The connector 13, which outwardly projects from the end wall 15, is inserted into a connector arranged in a vehicle transmitter (not shown) to mechanically connect the transmitter and the antenna device. Two terminals T10 and T11 extend from an end surface of the connector 13 in the direction of the first axis m1. The terminals T10 and T11 are arranged parallel to each other. Wires (not shown) are arranged in the first bobbin 1 to electrically connect the terminals T10 and T11 to the two ends of the first antenna coil 4.

As shown in FIG. 5, the end wall 15 of the first bobbin 1 includes two through holes 14. The two through holes 14 extend through the end wall 15 from the outer surface of the end wall 15 into the hollow interior of the first bobbin 1. As shown in FIGS. 3 and 4, each of the two through holes 14 is in communication with a recess that extends from the through hole 14 to one side surface of the flange 11.

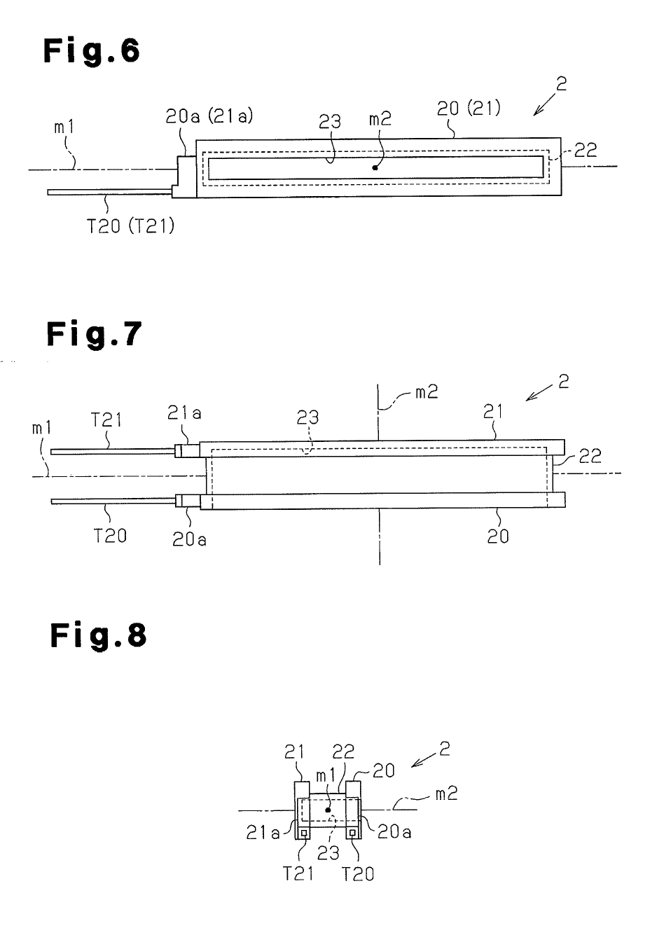

The structure of the second bobbin 2 will now be described with reference to FIGS. 6 to 8.

As shown in FIGS. 6 and 7, the second bobbin 2 includes flanges 20 and 21 located on two opposite sides. The second bobbin 2 includes a peripheral surface that defines a coil seat 22 around which the second antenna coil 5 is wound about the second axis m2. The flange 20 includes a projection 20a, which extends from one end of the flange 20 in the direction of the first axis m1. Further, the flange 21 includes a projection 21a, which extends from one end of the flange 21 in the direction of the first axis m1. The projection 20a includes a distal surface from which a terminal T20 extends in the direction of the first axis m1. The projection 21a includes a distal surface from which a terminal T21 extends in the direction of the first axis m1. The terminals T20 and T21 are arranged in parallel to each other. Wires (not shown) are arranged in the second bobbin 2 to connect the terminals T20 and T21 to the two ends of the second antenna coil 5.

Referring to FIG. 8, the interior of the second bobbin 2 defines an accommodation portion 23. The accommodation portion 23 has a recess-shaped cross-section in a direction orthogonal to the first axis m1. The accommodation portion 23 opens in the outer surface of the second bobbin 2 proximal to the flange 20. More specifically, the accommodation portion 23 includes an opening in an outer surface of the second bobbin 2 excluding the coil seat 22, that is, in the outer surface of the second bobbin 2 where the second antenna coil 5 does not contact. As shown in FIGS. 6 and 7, the accommodation portion 23 includes an opening, which is formed in the outer surface of the second bobbin 2 proximal to the flange 20, and a recess, which extends from the opening through the coil seat 22 and to the vicinity of the flange 21 in the second bobbin 2. The core 3 is accommodated in the accommodation portion 23.

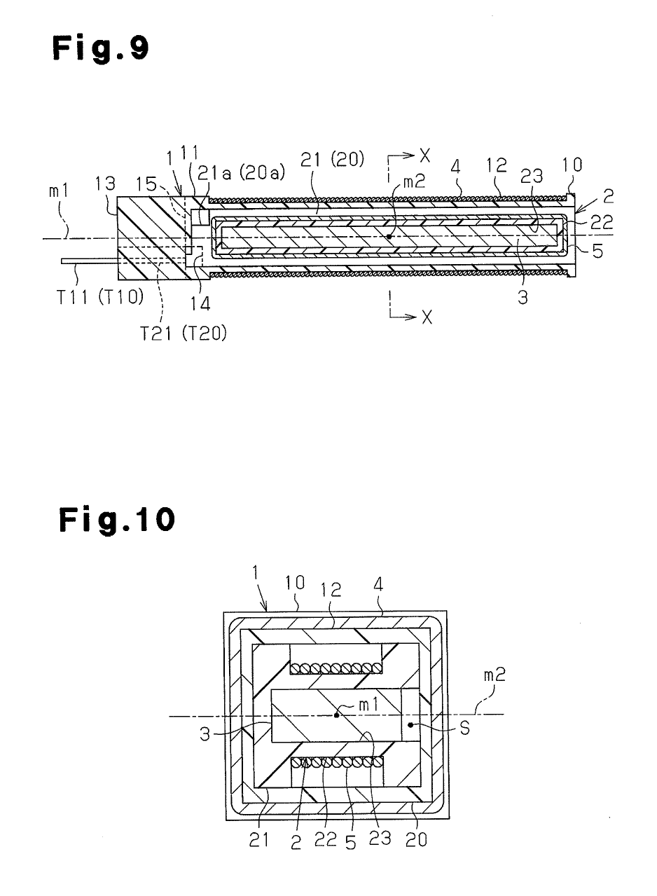

The second bobbin 2 is accommodated in the first bobbin 1 to form the antenna device. FIG. 9 shows the cross-sectional structure of the antenna device. Further, FIG. 10 shows the cross-sectional structure of the antenna device taken along line X-X in FIG. 9.

As shown in FIGS. 9 and 10, the second bobbin 2 is accommodated in the hollow interior of the first bobbin 1. Here, the second antenna coil 5 is wound around the coil seat 22 of the second bobbin 2, and the core 3 is accommodated in the accommodation portion 23 of the second bobbin 2. Further, the terminals T20 and T21 of the second bobbin 2 are inserted through the two through holes 14 in the end wall 15 of the first bobbin 1 and exposed from the first bobbin 1 as shown in FIG. 1. Further, as shown in FIG. 10, the inner wall surfaces of the first bobbin 1 are engaged with the outer wall surfaces of the second bobbin 2.

The operation of the antenna device of the present embodiment will now be described.

Referring to FIG. 1, in the antenna device of the present embodiment, the terminals T10, T11, T20, and T21 connected to the antenna coils 4 and 5 are all exposed from the connector 13 of the first bobbin 1. Thus, by merely fitting and connecting the connector 13 of the first bobbin 1 to the connector of the vehicle transmitter (not shown), a stable mechanical and electrical connection may be ensured between the vehicle transmitter and the antenna device.

As shown in FIG. 10, the outer wall surfaces of the second bobbin 2 are engaged with the inner wall surfaces of the first bobbin 1. This suppresses displacement of the second bobbin 2 relative to the first bobbin 1. Since relative displacement of the antenna coils 4 and 5 is suppressed, the desired antenna characteristics are easily ensured.

Further, by winding the two antenna coils 4 and 5 around the two bobbins 1 and 2 like in the present embodiment, the stress produced when winding the two antenna coils 4 and 5 act on the two bobbins 1 and 2. This reduces the stress acting on the core 3 in comparison with when the antenna coils is directly wound around the core 3. Thus, damage of the core 3 may be obviated.

The antenna device of the present embodiment has the advantages described below.

(1) The antenna device includes the first bobbin 1, around which the first antenna coil 4 is wound, and the second bobbin 2, around which the second antenna coil 5 is wound. The first bobbin 1 includes the end wall 15 and the hollow interior. Further, the first bobbin 1 includes the two terminals T10 and T11 arranged on the end wall 15 and electrically connected to the two ends of the first antenna coil 4. The through holes 14 extend through the end wall 15 to the hollow interior of the first bobbin 1. The second bobbin 2 includes the two terminals T20 and T21 electrically connected to the two ends of the second antenna coil 5. The second bobbin 2 is accommodated in the hollow interior of the first bobbin 1, and the two terminals T20 and T21 of the second bobbin 2 are inserted through the two through holes 14 of the first bobbin 1. In this manner, the terminals connected to the first and second antenna coils 4 and 5 are arranged proximal to the end wall 15 of the first bobbin 1. Thus, by merely connecting the end wall 15 of the first bobbin 1 to the connector of a communication device, the antenna device may be electrically connected to the communication device. This facilitates the connection of the antenna device and the communication device.

Further, the first bobbin 1 includes the connector 13 that outwardly projects from the end wall 15. The connector 13 includes the end surface on which the two terminals T10 and T11 of the first bobbin 1 are arranged. The two terminals T20 and T21 of the second bobbin 2 are arranged proximal to the connector 13. Thus, the insertion of the connector 13 of the first bobbin 1 into the connector of the communication device allows for a stable mechanical and electrical connection to be ensured between the vehicle transmitter and the antenna device.

(2) The first bobbin 1 includes inner wail surfaces engaged with the outer wall surfaces of the second bobbin 2. This suppresses relative displacement between the first and second antenna coils 4 and 5 and easily ensures the antenna characteristics.

(3) The second bobbin 2 includes the accommodation portion 23 that accommodates the core 3. The accommodation portion 23 includes an opening in the outer surface of the second bobbin 2 at a location other than where the second antenna coil 5 is in contact with. This reduces the stress acting on the core 3. Thus, damage of the core 3 may be obviated.

(4) The first antenna coil 4 is wound around the first bobbin 1 about the first axis ml, which is a center line of the first bobbin 1. Further, the second antenna coil 5 is wound around the second bobbin 2 about the second axis m2, which is orthogonal to the first axis m1. This easily realizes an antenna device having directivity in the directions of two orthogonal axes.

It should be apparent to those skilled in the art that the present invention may be embodied in many other specific forms without departing from the spirit or scope of the invention. Particularly, it should be understood that the present invention may be embodied in the following forms.

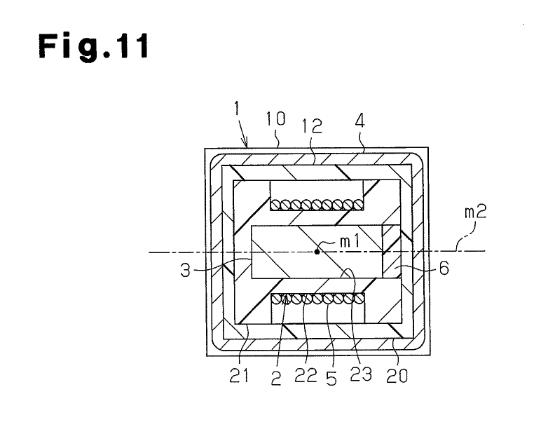

As shown in FIG. 10, when a gap S is formed between the core 3 and the inner wall of the coil seat 12 in the first bobbin 1, the core 3 may be displaced. To obviate such displacement, as shown in FIG. 11, a spacer 6 formed from, for example, a resin may be arranged in the gap S. This obviates displacement of the core 3 and ensures that she antenna characteristics are easily obtained.

In the above embodiment, the accommodation portion 23 of the second bobbin 2 has a recess-shaped cross-section but may have any form. For example, the accommodation portion 23 may extend through the second bobbin 2 from the outer surface of the side proximal to the flange 20 to the opposite outer surface of the second bobbin 2.

The bobbins 1 and 2 of the antenna device may be changed in form. For example, the first bobbin 1 may have the form of a hollow cylinder and the second bobbin 2 may have the form of a solid cylinder as long as the first coil antenna 4 is wound around the first bobbin 1, the first bobbin 1 includes a hollow interior, the second antenna coil 5 is wound around the second bobbin 2, and the second bobbin 2 is accommodated in the hollow interior of the first bobbin 1.

In the above embodiment, the antenna axes of the two antenna coils 4 and 5 are orthogonal to each other. However, for example, the coil seats 12 and 22 of the bobbins 1 and 2 may be changed in form to change the directions of the antenna axes of the two antenna coils 4 and 5.

The above embodiment exemplifies a case in which the terminals T10, T11, T20, and T21 of the bobbins 1 and 2 are all connected to the transmitter. Instead, for example, just the terminals T10 and T11 of the first bobbin 1 may be connected to the transmitter. Alternatively, just the terminals T20 and T21 of the second bobbin 2 may be connected to the transmitter. This allows for the two antenna coils 4 and 5 to be independently driven.

In the above embodiment, the second bobbin 2 includes the accommodation portion 23. The accommodation portion 23, which includes an opening in the outer surface of the second bobbin 2, accommodates the core 3. Instead, the core 3 may be embedded in the second bobbin 2. Alternatively, the core 3 may be omitted.

The above embodiment is exemplified in a transmission antenna device arranged in the handle of a vehicle door. However, the antenna device may be arranged at a different location in a vehicle. The antenna device may also be arranged in a machine other than a vehicle. Further, the antenna device of the above embodiment may be used to receive signals.

The present examples and embodiments are to be considered as illustrative and not restrictive, and the invention is not to be limited to the details given herein, but may be modified within the scope and equivalence of the appended claims.

1. An antenna device comprising:
a first bobbin including an end wall and a hollow interior, wherein a first antenna coil is wound around the first bobbin; and
a second bobbin around which a second antenna coil is wound, wherein
the first bobbin includes two terminals arranged on the end wall and electrically connected to two ends of the first antenna coil, respectively,
the end wall includes two through holes that extend to the hollow interior of the first bobbin,
the second bobbin includes two terminals electrically connected to two ends of the second antenna coil, respectively,
the second bobbin is accommodated in the hollow interior of the first bobbin, and
the two terminals of the second bobbin are inserted through the two through holes, respectively.

2. The antenna device according to claim 1, wherein
the first bobbin includes a connector that outwardly projects from the end wall,
the connector includes an end surface on which the two terminals of the first bobbin are arranged, and
the two terminals of the second bobbin are arranged proximal to the connector.

3. The antenna device according to claim 1, wherein the first bobbin includes an inner wall surface engaged with an outer wall surface of the second bobbin.

4. The antenna device according to claim 1, further comprising a core accommodated in the second bobbin, wherein
the first antenna coil is wound around the first bobbin about a first axis that is a center line of the first bobbin, and
the second antenna coil is wound around the second bobbin about a second axis that is orthogonal to the first axis.

5. The antenna device according to claim 4, wherein
the second bobbin includes an accommodation portion that accommodates the core, and
the accommodation portion includes an opening in an outer surface of the second bobbin at a location other than where the second antenna coil is in contact with.

6. The antenna device according to claim 4, further comprising a spacer that fills a gap between the core and an inner wall surface of the first bobbin.
